(19) United States
(12) Patent Application Publication
(10) Pub. No.: US 2003/0204451 A1
(43) Pub. Date: Oct. 30, 2003

(54) System and method for exchanging supply-own-inventory related information between manufacturer and supplier

(75) Inventors: Te-Mei Chu, Taipei (TW); Shu-Mei Chien, Taipei (TW); Yun-Chi Lee, Taipei (TW); Kuan-I Wu, Taipei (TW)

Correspondence Address: Finnegan, Henderson, Farabow,, Garrett & Dunner, L.L.P., 1300 I Street, N.W., Washington, DC, 20005-3315, US

(73) Assignee: INVENTEC CORPORATION

(21) Appl. No.: 10/227,479

(22) Filed: Aug. 26, 2002

(30) Foreign Application Priority Data
Apr. 26, 2002 (TW) 91108631

(51) Int. Cl. G06F 17/60

(52) U.S. Cl. 705/28; 709/219

(57) ABSTRACT

A system and method is proposed for exchanging SOI (Supply Own Inventory) related information between a manufacturer and a supplier, allowing both the manufacturer and the supplier to learn all SOI-related information, including the supplier's extra amount of material stocked at the manufacturer's site, the amount of material taken by the manufacturer to supply its own inventory, and the amount of the supplier's assured resupply to the manufacturer's inventory stock during a specific future period, etc., so as to allow both the supplier and the manufacturer to perform related management tasks more efficiently. The proposed system and method is characterized by the use of a server to serve up an online inventory management system including an SOI-status inquiry Web page and an SOI-status display Web page, which can be accessed via a network system, such as extranet or Internet, by both the manufacturer and the supplier.

### BACKGROUND OF THE INVENTION

1. Field of the Invention

This invention relates to network-based information technology, and more particularly, to a system and method for exchanging SOI (Supply Own Inventory) related information between a manufacturer and a supplier to allow both the manufacturer and the supplier to learn all the SOI-related information, including the information about the supplier's extra amount of material stocked at the manufacturer's site, the information about the amount of material taken by the manufacturer, and the information about the amount of the supplier's assured resupply to the manufacturer's inventory stock during a specific future period, etc., so as to allow both the supplier and the manufacturer to perform related transaction tasks more efficiently to thereby prevent undersupply or oversupply.

2. Description of Related Art

In the manufacture industry, such as the CEM (Contract Electronics Manufacture) industry, the manufacturer depends on a supplier for supply of material such as electronic components, for the assembly of various electronic products, such as computers or the like. To make manufacture highly efficient, it is an important task for both the manufacturer and the supplier to be fully aware of the manufacturer's current inventory stock status and future demand and the supplier's supply capability, so as to allow the manufacturer to perform inventory management tasks more efficiently and allow the supplier to prepare well in advance to prevent oversupply or undersupply.

In the business relation between manufacturer and supplier, the supplier usually stock an extra amount of material at the manufacturer's site that meets the manufacturer demand during a future period, so that the manufacturer can take needed material from this extra stock to meet its demand immediately on site. This practice is customarily referred to as a supply-own-inventory (SOI) scheme. After performing an SOI action, the manufacturer needs to issue a notice to the supplier to inform the supplier about the amount of material being taken by the manufacturer, allowing the supplier to learn the current status of the stock of material at the manufacturer's site and perform resupply operation, if necessary.

Traditionally, the exchange of SOI-related information, including the information about the supplier's extra amount of material stocked at the manufacturer's site, the information about the amount of material taken by the manufacturer, and the information about the amount of the supplier's assured resupply to the manufacturer's inventory stock during a specific future period, etc., is carried out by using printed documents.

One drawback to the conventional paperwork-based transaction method, however, is that the use of printed documents for exchanging all the SOI-related information is quite laborious and time-consuming and would not allow real-time exchange and update of the SOI-related information, making the transaction between the manufacturer and the supplier unsatisfactorily inefficient.

### SUMMARY OF THE INVENTION

It is therefore an objective of this invention to provide a system and method for exchanging SOI-related information between manufacturer and supplier, which allows the supplier and the manufacturer to exchange SOI-related information in a real-time, online manner so as to allow both the supplier and the manufacturer to perform related transaction tasks more efficiently to thereby prevent undersupply or oversupply.

The system and method of the invention is intended for use by a manufacturer and a supplier to allow both the manufacturer and the supplier to learn all SOI-related information, including the supplier's extra amount of material stocked at the manufacturers site, the amount of material taken by the manufacturer to supply its own inventory, and the amount of the supplier's assured resupply to the manufacturer's inventory stock during a specific future period, etc., so as to allow both the supplier and the manufacturer to perform related management tasks more efficiently.

The system and method of the invention is characterized by the use of a server to serve up an online inventory management system including an SOI-status inquiry Web page and an SOI-status display Web page, which can be accessed via a network system, such as extranet or Internet, by both the manufacturer and the supplier.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the system architecture of the system for exchanging SOI-related information between manufacturer and supplier according to the invention;

FIG. 2A shows an example of an SOI-status inquiry Web page provided by the system and method according to the invention;

FIG. 2B shows an example of an SOI-status display Web page provided by the system and method according to the invention;

FIG. 3 is a flow diagram showing the procedural steps carried out by the system and method according to the invention.

### DETAILED DESCRIPTION OF PREFERRED EMBODIMENTS

The system and method for exchanging SOI-related information between manufacturer and supplier according to the invention is disclosed in full details by way of preferred embodiments in the following with reference to the accompanying drawings.

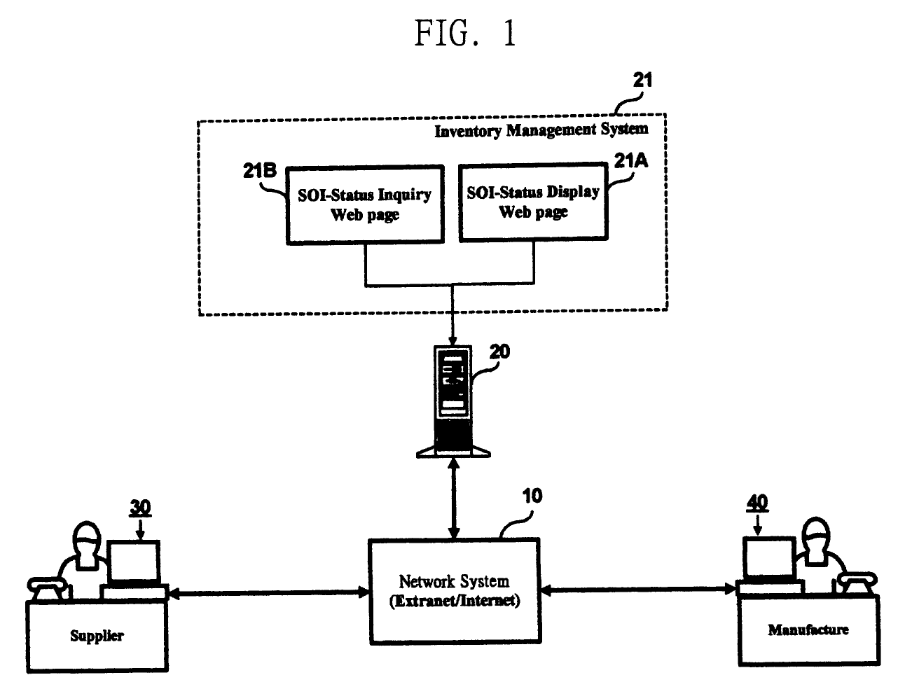

FIG. 1 is a schematic diagram showing the architecture of the system for exchanging SOI-related information between manufacturer and supplier according to the invention. As shown, the system according to the invention comprises: (a) a network system 10; (b) a server 20; (c) at least one first-party workstation 30; and (d) at least one second-party workstation 40, and which is intended for use by a supplier (i.e., the first party) and a manufacturer (i.e., the second party) to inquire for SOI (Supply Own Inventory) related information in an real-time online manner via the network system 10.

The network system 10 can be Internet or an extranet system dedicatedly established between the supplier and the manufacturer, and which is linked to the server 20, the first-party workstation 30, and the second-party workstation 40 to allow the server 20, the first-party workstation 30, and the second-party workstation 40 to exchange data there-through.

The server 20 is linked to the network system 10 and is used to serve up an online inventory management system 21 which includes an SOI-status inquiry Web page 21A and an SOI-status display Web page 21B. Any authorized workstations (i.e., the first-party workstation 30 or the second-party workstation 40) can gain access to the SOI-status inquiry Web page 21A and the SOI-status display Web page 21B by linking via the network system 10 to the inventory management system 21 on the server 20.

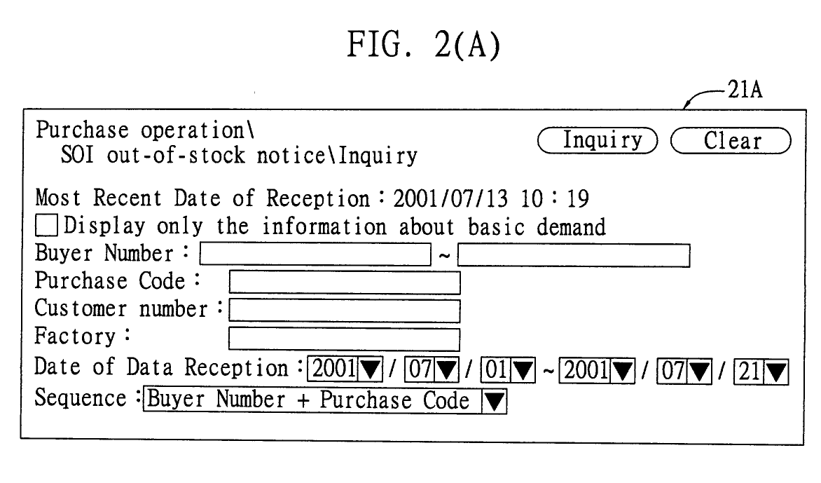

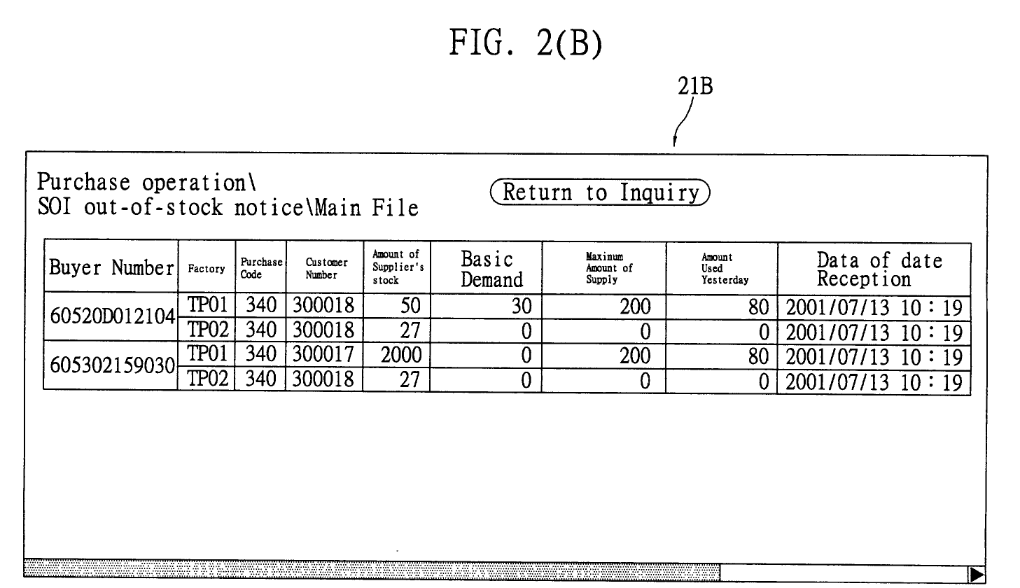

FIG. 2A shows an example of the SOI-status inquiry Web page 21A. This SOI-status inquiry Web page 21A can be accessed by either the manufacturer or the supplier to inquire about the manufacturer's SOI-related information including the current status information about the supplier's extra amount of material stocked at the manufacturer's site and the information about the amount of assured resupply to the manufacturer's inventory stock during a specific future period.

FIG. 2B shows an example of the SOI-status display Web page 21B. This SOI-status display Web page 21B allows the manufacturer to record the amount of material that has been taken from the supplier's extra amount of material stocked at the manufacturer's site, so as to allow the supplier to learn the related information by browsing the contents thereof. In addition, the SOI-status display Web page 21B allows the supplier to compute for the manufacturer's demand during a specific future period based on the geographic distance between the supplier and the manufacturer and/or the manufacturer's expected rate of material input. For example, if the geographic distance between the supplier and the manufacturer is short, the supplier can use the SOI-status display Web page 21B to compute for the manufacturer's demand on the next day; and whereas if the distance is long, the supplier will use it to compute for the manufacture's demand during the period of next 2 or 4 days. The manufacturer's expected rate of material input is dependent on the volume of the demanded material and the storage capacity of the manufacturer's warehouse.

The first-party workstation 30 is a computer unit on the supplier side, which can utilize a Web browser program, such as Microsoft Internet Explorer or Netscape Navigator, to link via the network system 10 to the inventory management system 21 on the server 20 for the purpose of browsing the contents of the SOI-status inquiry Web page 21A or the SOI-status display Web page 21B.

The second-party workstation 40 is a computer unit on the manufacturer side, which can utilize a Web browser program, such as Microsoft Internet Explorer or Netscape Navigator, to link via the network system 10 to the inventory management system 21 on the server 20 for the purpose of browsing the contents of the SOI-status inquiry Web page 21A and the SOI-status display Web page 21B.

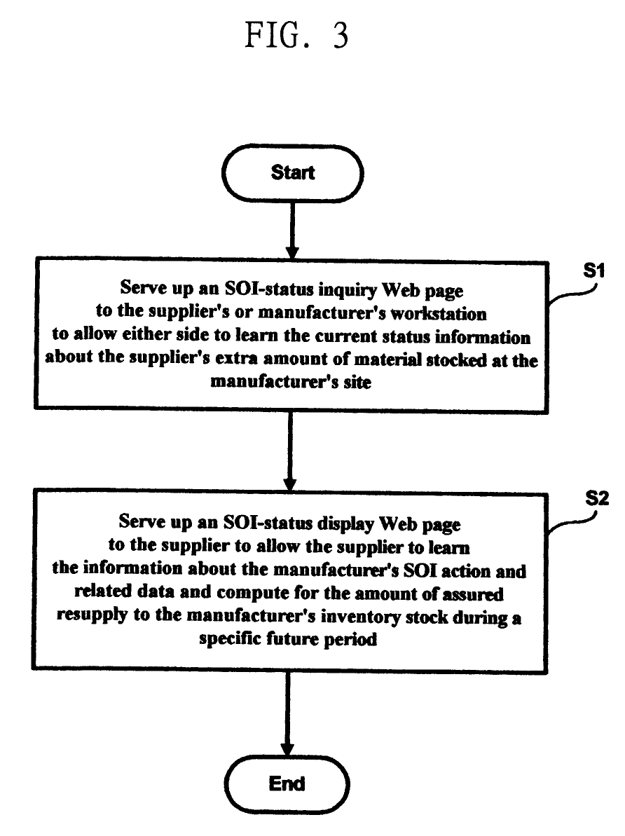

FIG. 3 is a flow diagram showing the procedural steps carried out by the system and method for exchanging SOI-related information between the manufacturer and the supplier according to the invention.

As shown, the first step S1 is to serve up the SOI-status inquiry Web page 21A to a linked workstation, either the first-party workstation 30 on the supplier side or the second-party workstation 40 on the manufacturer side, to allow any taskforce member on the supplier side or the manufacturer side to learn the current status information about the supplier's extra amount of material stocked at the manufacturer's site. Either the first-party workstation 30 or the second-party workstation 40 can use a Web browser program, such as Microsoft Internet Explorer or Netscape Navigator, to link via the network system 10 to the SOI-status inquiry Web page 21A in the inventory management system 21 on the server 20 to thereby use the SOI-status inquiry Web page 21A to gain access to the SOI-status display Web page 21B to learn the current status information about the supplier's extra amount of material stocked at the manufacturer's site and the information about the amount of the supplier's assured resupply to the manufacturer's inventory stock during a specific future period.

In the next step S2, in the event that the manufacturer performs an SOI action by taking all or part of the supplier's extra amount of material stocked at the manufacturer's site, the manufacturer is required to post the related data on the SOI-status display Web page 21B, allowing related personnel on both the manufacturer side and the supplier side to learn the SOI-related information by utilizing the first-party workstation 30 or the second-party workstation 40 to link via the network system 10 to the SOI-status display Web page 21B in the inventory management system 21 on the server 20 to browse the contents of the SOI-status display Web page 21B.

In addition, the supplier can utilize the SOI-status display Web page 21B to compute for the manufacturer's demand during a specific future period based on the geographic distance between the supplier and the manufacturer and/or the manufacturer's expected rate of material input. For example, if the geographic distance between the supplier and the manufacturer is short, the supplier can use the SOI-status display Web page 21B to compute for the manufacturer's single-day demand on the next day; and whereas if the distance is long, the supplier will use it to compute for the manufacture's demand during the period of next 2 or 4 days. The manufacturer's expected rate of material input is dependent on the volume of the demanded material and the storage capacity of the manufacturer's warehouse. This allows the supplier to reduce transportation cost of the material supply to the manufacturer and always can satisfy the manufacturer's demand.

In conclusion, the invention provides a system and method for exchanging SOI-related information between manufacturer and supplier, which is characterized by the use of a server to serve up an SOI-status inquiry Web page and an SOI-status display Web page via extranet or Internet, allowing both parties to learn the current status information about the supplier's extra amount of material stocked at the manufacturer's site and the information about the amount of the supplier's assured resupply to the manufacturer's inventory stock during a specific future period. This feature allows the supplier to be more efficient in its inventory management and resupply operations to thereby prevent under-supply or oversupply and also allow the manufacturer to be more efficient in its purchase management and manufacturing operations.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

what is claimed is:

1. A method for exchanging SOI-related information between a manufacturer and a supplier in an online manner via a network system linked to a first-party workstation on the supplier side and a second-party workstation on the manufacturer side;
the method comprising:
serving up an SOI-status inquiry Web page via the network system to the second-party workstation for the manufacturer to post SOI-related information on the SOI-status inquiry Web page;
serving up the SOI-status inquiry Web page via the network system to the first-party workstation for the supplier to learn the current status information about the supplier's extra amount of material stocked at the manufacturer's site;
in the event that the manufacturer performs an SOI action on the supplier's extra amount of material stocked at the manufacturer's site,, serving up the SOI-status display Web page to the manufacturer, allowing the manufacturer to post SOI-related information on the SOI-status display Web page, so that the supplier can learn the SOI-related information by linking the first-party workstation via the network system to the SOI-status display Web page in the inventory management system on the server; and in addition, the supplier can utilize the SOI-status display Web page to compute for the manufacturer's demand during a specific future period based on the geographic distance between the supplier and the manufacturer and/or the manufacturer's expected rate of material input so as to obtain the information about the amount of the supplier's assured resupply to the manufacturers inventory stock during a specific future period.

2. The method of claim 1, wherein the manufacturer's expected rate of material input is dependent on the volume of the demanded material and the storage capacity of the manufacturer's warehouse.

3. The method of claim 1, wherein the network system is selected from the types comprising Internet and extranet system.

4. The method of claim 1, wherein the first-party workstation and the second-party workstation each utilizes a Web browser program to link to the SOI-status inquiry Web page and the SOI-status display Web page in the inventory management system on the server and browse the contents thereof.

5. The method of claim 1, wherein the Web browser program is Microsoft Internet Explorer.

6. The method of claim 1, wherein the Web browser program is Netscape Navigator.

7. A system for exchanging SOI-related information between a manufacturer and a supplier, which comprises:
(a) a network system;
(b) a server, which is linked to the network system, and which is used to serve up an online inventory management system including a SOI-status inquiry Web page and a SOI-status display Web page;
(c) at least one first-party workstation, which is installed on the supplier side, and which is linkable via the network system to the inventory management system on the server; and
(d) at least one second-party workstation, which is installed on the manufacturer side, and which is linkable via the network system to the inventory management system on the server;
wherein
the server is capable of serving the SOI-status inquiry Web page to either the first-party workstation or the second-party workstation to allow either the supplier or the manufacturer to learn the current status information about the supplier's extra amount of material stocked at the manufacturer's site;
and wherein
in the event that the manufacturer performs an SOI action on the supplier's extra amount of material stocked at the manufacturer's site, the server is capable of serving up the SOI-status display Web page to the manufacturer, allowing the ma nufacturer to post the SOI-related information on the SOI-status display Web page, so that the supplier can learn the SOI-related information by linking the first-party workstation via the network system to the SOI-status display Web page in the inventory management system on the server; and in addition, the supplier can utilize the SOI-status display Web page to compute for the manufacturer's demand during a specific future period based on the geographic distance between the supplier and the manufacturer and/or the manufacturer's expected rate of material input so as to obtain the information about the amount of the supplier's assured resupply to the manufacturer's inventory stock during a specific future period.

8. The system of claim 7, wherein the manufacturer's expected rate of material input is dependent on the volume of the demanded material and the storage capacity of the manufacturer's warehouse.

9. The system of claim 7, wherein the network system is selected from the types comprising Internet and extranet system.

10. The system of claim 7, wherein first-party workstation and the second-party workstation each utilizes a Web browser program to link to the SOI-status inquiry Web page and the SOI-status display Web page in the inventory management system on the server and browse the contents thereof.

11. The system of claim 10, wherein the Web browser program is Microsoft Internet Explorer.

12. The system of claim 10, wherein the Web browser program is Netscape Navigator.
